(19) United States
(12) Patent Application Publication
(10) Pub. No.: US 2023/0196087 A1
(43) Pub. Date: Jun. 22, 2023

(54) INSTANCE ADAPTIVE TRAINING WITH NOISE ROBUST LOSSES AGAINST NOISY LABELS

(71) Applicant: TENCENT AMERICA LLC, Palo Alto, CA (US)

(72) Inventors: Lifeng Jin, Palo Alto, CA (US); Linfeng Song, Palo Alto, CA (US); Kun Xu, Bellevue, WA (US); Dong Yu, Bothell, WA (US)

(73) Assignee: TENCENT AMERICA LLC, Palo Alto, CA (US)

(21) Appl. No.: 17/510,782

(22) Filed: Oct. 26, 2021

(51) Int. Cl. G06N 3/08; G06N 3/04; G06K 9/62

(52) U.S. Cl. CPC G06N 3/08; G06K 9/6256; G06N 3/0454

(57) ABSTRACT

There is included a method and apparatus comprising computer code for a joint training method using neural networks with noise-robust losses comprising encoding input tokens from a noisy dataset into input vectors using an input encoder; predicting a label based on the input vectors using a classifier model; calculating a beta value based on the input vectors and the label using a label quality predictor model, wherein the beta value is instance-specific for each training instance; and j oint training more than one model using a first modified loss function based on the beta value and an entropy value.

### FIELD

Embodiments of the present disclosure are directed to the field of natural language processing. More specifically, the present disclosure is directed to noisy labels generated during the automated annotation generation process.

### BACKGROUND

To meet the demand of annotated datasets for different tasks, many natural language processing datasets include automated pipelines for fast-tracking data annotation. In these datasets with automated annotation, labels for input data are generated by machine learning algorithms and not human annotators. Labels generated using machine learning are known as silver labels.

However, silver labels generated using machine learning are very noisy compared to human annotation. Using such annotated datasets for training models comes with its own challenges because of their noisiness. Popular optimization objectives are not robust to label noise created during the automated annotation process. Using Cross Entropy (CE) loss as the optimization objective has shown to overfit to label noise, because trained models spend a lot of resources trying to capture the noisy correlation between input data and the noisy silver labels.

Several noise-robust losses have been proposed but they generally have a single dataset-wide hyper parameter to control the noise resistance. However, individual training instances may have different amounts of noise, derived from biases within models used during the automated annotation process.

### SUMMARY

The present disclosure addresses one or more technical problems. Using a noise-robust loss with a dataset-specific noise-robust parameter to capture how noise robust the annotated labelling is, ignores that different data points in the training set have different levels of noise. Instead, using a noise-robust parameter that is instance-specific may capture the noise robustness better by accounting for different levels of noise in the dataset. Using noise-robust training objectives with instance-adaptive training frameworks enhances their noise-robustness, and improves accuracy of the trained models, which in turn benefit downstream applications that they serve.

According to embodiments, an apparatus for joint training using neural networks with noise-robust losses, the apparatus comprising at least one memory configured to store computer program code; at least one processor configured to access the computer program code and operate as instructed by the computer program code, the computer program code including: first encoding code configured to cause the at least one processor to encode input tokens from a noisy dataset into input vectors using an input encoder; first predicting code configured to cause the at least one processor to predict a label based on the input vectors using a classifier model; first calculating code configured to cause the at least one processor to calculate a beta value based on the input vectors and the label using a label quality predictor model, wherein the beta value is instance-specific for each training instance; and first joint training code configured to cause the at least one processor to jointly train more than one model using a first modified loss function based on the beta value and an entropy value.

According to embodiments, wherein the first joint training code further comprises second joint training code configured to cause the at least one processor to jointly train the classifier model, the input encoder, and the label quality predictor model using the first modified loss function.

According to embodiments, wherein the input encoder and the label quality predictor model are jointly trained using training data sampled from an auxiliary dataset, and wherein the auxiliary dataset comprising a manual correctness label which indicates a manual correctness of a corresponding label in the noisy dataset.

According to embodiments, wherein the joint training of the input encoder and the label quality predictor model comprises: second encoding code configured to cause the at least one processor to encode input tokens from the auxiliary dataset into auxiliary input vectors using the input encoder; second calculating code configured to cause the at least one processor to calculate an auxiliary beta value based on the auxiliary input vectors and an annotated label in the auxiliary dataset, wherein the auxiliary beta value is instance-specific for the each training instance; and third joint training code configured to cause the at least one processor to jointly train the input encoder and the label quality predictor model using a second modified loss function based on the auxiliary beta value and the manual correctness label.

According to embodiments, wherein the first joint training code further comprises second joint training code configured to cause the at least one processor to jointly train the classifier model and the input encoder using a first modified loss function.

According to embodiments, wherein prior to the first calculating code, the beta value is set to one for a limited number of epochs.

According to embodiments, wherein the beta value is higher than a threshold.

According to embodiments, wherein the manual correctness label is set to 1 if the corresponding label in the noisy dataset is accurate.

According to embodiments, wherein the beta value is lower bounded by a function of beta mu.

### BRIEF DESCRIPTION OF THE DRAWINGS

Further features, nature, and various advantages of the disclosed subject matter will be more apparent from the following detailed description and the accompanying drawings in which:

FIG. 1 is a diagram of an environment in which methods, apparatuses and systems described herein may be implemented, according to embodiments.

FIG. 2 is a diagram of example components of one or more devices of FIG. 1.

FIG. 3 is a simplified block diagram of illustrating a common training for classification model according to embodiments of the disclosure.

FIG. 4 is a simplified block diagram of illustrating a joint training for classification model according to embodiments of the disclosure.

FIG. 5 is a simplified block diagram of illustrating an iterative training for classification model according to embodiments of the disclosure.

FIG. 6 is a simplified flowchart for a training method according to the embodiments of the disclosure.

FIG. 7 is a simplified flowchart for a training method according to the embodiments of the disclosure.

FIG. 8 is a simplified flowchart for a training method according to the embodiments of the disclosure.

FIG. 9 is a simplified flowchart for a training method according to the embodiments of the disclosure.

### DETAILED DESCRIPTION

The present disclosure relates to an instance-specific noise-robust hyperparameter allowing the noise-robust properties of the learning be more targeted and fine-grained. Manually tuning the noise-robust hyperparameter may be difficult because there may be thousands of training instances. However, tuning the noise-robust hyperparameter while training main classification models may not only overcome the problem of manually tuning the noise-robust hyperparameter, but also may leverage any correlation that exists between label quality and input features. Such instance-specific noise-robust training using label quality predictors and a noise-robust hyperparameter enhances the noise-robustness of the losses on noisy and corrupted datasets, resulting in large performance gains.

A noise-robust training objective may be described as follows. As an example, GCE is a noise-robust training objective with a dataset-specific noise-robust parameter, which is the negative Box-Cox transformation of the predicted distribution d from the model under training, as shown in Equation 1 below:

$$\text{GCE} \left(\text{y,d}\right) = \frac{1 - {\text{y}}^{\text{T}} \left({\text{d}}^{1 - β}\right)}{1 - β}$$

Here, y is the noisy label, d is the predicted distribution, and β (beta) is the dataset-specific noise-robust parameter. However, as previously mentioned, a dataset-specific noise-robust hyperparameter does not take into consideration that different data points in the training set may have different noise-levels.

To overcome this deficiency, a modified β may be used. According to embodiments of the present disclosure, a modified loss by changing β to be instance-specific and applying an entropy term to the loss to further regularize it may be defined as shown in Equation 2 below:

$$\begin{matrix}\text{ER} ⋅ \text{GCE} \left(\text{y,d}\right) = \frac{β \left(1 - {\text{y}}^{\text{T}} \left({\text{d}}^{1 - β}\right)\right)}{1 - β} \\ + \left(1 - β\right) H \left(\text{d}\right) .\end{matrix}$$

Here, the H function represents the entropy function for the distribution d. The β in this modified loss function controls both the CE in the GCE objective as well as the weight of the entropy regularizer. In some embodiments, ER-GCE may be more noise-robust than GCE when the following condition shown in Equation 3 is satisfied:

$$\begin{matrix}\frac{β \left(K - {K}^{β}\right)}{1 - β} + \left(1 - β\right) K log K \leq \\ {\sum }_{k = 1}^{K} \text{ER} - \text{GCE} \left(\text{d} , \text{k}\right) \leq \frac{β \left(K - 1\right)}{1 - β} ,\end{matrix}$$

According to the embodiments of the present disclosure instance-adaptive or instance-specific noise-robust training using different β for each instance of training data. The different β for each instance of training data may be calculated using a label quality function. The label quality function may be a neural network expected to capture the complex relationship between inputs and quality of silver labels. According to some embodiments, instance-adaptive noise-robust training may include training the main classification model or main task model and the label quality predictor jointly. According to some embodiments, instance-adaptive noise-robust training may include additional supervision of label quality with joint training of the main classification model or main task model and the label quality predictor.

In some embodiments, instance-adaptive noise-robust training may include training the main classification model or main task model and the label quality predictor jointly. As an example, there may be two components for a classification task, an input encoder and a classifier that makes label predictions. In some embodiments, the input encoder may encode the input tokens into vectors. The classifier may use the encoded input and make a label prediction for the instance. Each training instance may include an annotated label associated with it. Using the encoded input and the annotated label associated with that input, a label quality predictor learns to analyze them and predict a β value for that training instance. Using the instance-specific β value, a modified loss, a ER-GCE model as an example, may train the input encoder, the classifier, and the label quality predictor jointly. An example algorithm may be described as shown in Table 1 below:

TABLE 1

Algorithm 1: Joint instance-adaptive noise-robust training

| | input: | Training data D, max number of epochs E, | |
|---|---|---|---|
| | | number of iterations per epoch T, | |
| | | noise-robust loss L | |
| | output: | Trained models ε^{(ε)} C^{(E)}, Q^{(E)} | |
| 1 | initialize input encoder ε⁽⁰⁾ classifier C⁽⁰⁾ , quality | | |
| | predictor Q⁽⁰⁾ | | |
| 2 | for e = 0 to E - I do | | |
| 3 | \| | for t = 0 to T - I do | |
| 4 | \| | \| | {x, y} ← SampleBatch(D) |
| 5 | \| | \| | H ← E(x);d ←C(H) |
| 6 | \| | \| | β ← Q(H,y) |
| 7 | \| | \| | l ← L(y,d,p) |
| 8 | \| | \| | update all models w.r.t l |
| 9 | \| | end | |
| 10 | end | | |

In some embodiments, noise-robust losses may require the instance-specific β value to be set above a threshold. Having the instance-specific β value higher than the threshold may allow for a good balance of noise-robustness and fast convergence in the models. Lower β_{µ} may indicate higher noise-robustness and slower convergence. In some embodiments, when β_{µ} reaches 1, the loss may be represented by the common cross entropy loss. In some embodiments, the instance-specific β value may be lower-bound by β_{µ} (beta mu). In some embodiments, β_{µ} may be defined as shown in Equation 4 below:

$$β = β \times \left({β}_{\text{upper}} - {β}_{p}\right) + {β}_{p} : {β}_{p} ∈ \left(0 , 1\right)$$

In some embodiments, to better train the label quality predictor model and the main task model, instance-specific β values may be set to 1 for a certain number of epochs before joint training the label quality predictor model and the main task model. Setting the instance-specific β value to be 1 for certain epochs while the model warms up, may provide more meaningful instance-specific β values.

According to embodiments, the input encoder, classifier, and the label quality predictor may be implemented through any machine learning models.

According to some embodiments, instance-adaptive noise-robust training may include additional supervision of label quality with joint training of the main classification model or main task model and the label quality predictor. As an example, in some embodiments, an auxiliary dataset may be used to provide additional supervision to the label quality predictor model. Correcting the original annotations on the original training set may be expensive. However, using a manual correctness label in the auxiliary dataset that indicates only manual correctness of the original annotations on the original training set may provide a less expensive method to measure the correctness of the original annotations. The manual correctness label may help better capture the relationship between the input, the original label, and the noise-level of the instance. In some embodiments, if the original label is correct, the manual correctness label may be 1, otherwise zero. In some embodiments, if the original label is incorrect, the manual correctness label may be zero, otherwise 1.

In some embodiments, the auxiliary dataset including the manual correctness labels for training instances may be used to train the main classification or main task model and the label quality predictor model. In some embodiments, the training of the main task model, the label quality predictor model, and the input encoder may be iterative. As an example, at first the classification model and the label quality predictor model may be jointly trained using training instances sampled from the auxiliary dataset. Then, the input encoder and the classification model may be jointly trained using instance-specific β values from the label quality predictor model. In some embodiments, the label quality predictor may not be updated using the instance-specific β values while the input encoder and the classification model may be jointly trained.

An example algorithm may be described as shown in Table 2 below:

TABLE 2

Algorithm 2: Iterative instance-adaptive noise-robust training

| | input: | Training data D, auxiliary data A, max | |
|---|---|---|---|
| | | number of epochs E, number of iterations | |
| | | per epoch T_{D}, number of iterations per epoch | |
| | | T_{A} for auxiliary data, noise-robust loss L | |
| | output: | Trained models ε⁽^{E)} C^{(E)}, Q^{(E)} | |
| 1 | initialize input encoder ε⁽⁰⁾ classifier C⁽⁰⁾, quality | | |
| | predictor Q⁽⁰⁾ | | |
| 2 | for e = 0 to E - 1 do | | |
| 3 | \| | for t_{A} = 0 to T_{A} - 1 do | |
| 4 | \| | \| | {x, y, y_{A}}← SampleBatch(A) |
| 5 | \| | \| | H ← ε(x) |
| 6 | \| | \| | β ← Q(H, y) |
| 7 | \| | \| | l_{A} ← BinaryCrossEntropy(β, y_{A}) |
| 8 | \| | \| | update ε, Q models w.r.t l_{A} |
| 9 | \| | end | |
| 10 | \| | for t = 0 to T - 1 do | |
| 11 | \| | \| | {x, y} ← SampleBatch(D) |
| 12 | \| | \| | H← ε(x); d←C(H) |
| 13 | \| | \| | β ← StopGradient(Q(H,y)) |
| 14 | \| | \| | l ← L (y, d, β) |
| 15 | \| | \| | update ε, C models w.r.t l |
| 16 | \| | end | |
| 17 | end | | |

According to experimental analyses, as shown for example in Table 3 below the performances of the joint training methods described in the present disclosure indicate strong noise-robust properties, outperforming noise-robust training objectives when no instance-adaptive training is used.

TABLE 3

| Loss | GTKY | | | eCSRL | | | Loss Mean |
|---|---|---|---|---|---|---|---|
| | Fix | Joint | Iterative | Fix | Joint | Iterative | |
| CE | 35.1 | - | - | 44.2 | - | - | 39.7 |
| WCE | 35.2 | 36.4 | 37.8 | 44.3 | 46.5 | 47.3 | 41.7 |
| BSLₛ | 36.5 | 38.6 | 39.4 | 49.7 | 49.5 | 50.7 | 44.1 |
| BSL_{b} | 36.5 | 38.4 | 39.3 | 49.2 | 50.1 | 50.9 | 44.1 |
| GCE | 38.6 | 39.7 | 39.4 | 50.6 | 50.7 | 51.2 | 45.0 |
| SCE | 36.3 | 38.1 | 39.1 | 50.6 | 51.8 | 52.1 | 44.7 |
| ER-GCE | 39.1 | 39.7 | 40.5 | 50.3 | 51.1 | 52.2 | 45.5 |
| Framework Mean | 37.0 | 38.5 | 39.3 | 49.1 | 50.0 | 50.7 | - |

The ER-GCE performs the best among all noise-robust training objectives. Such results show that using noise-robust training objectives with instance-adaptive training enhances noise-robustness, and improves accuracy of the trained models, which in turn benefit downstream applications that they may serve.

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

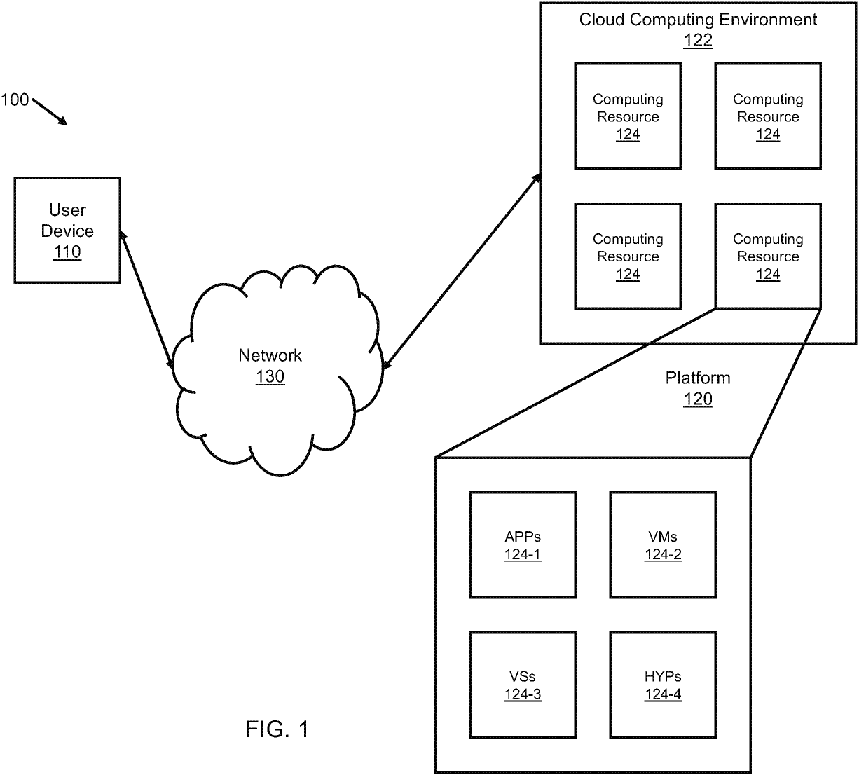

FIG. 1 is a diagram of an environment 100 in which methods, apparatuses and systems described herein may be implemented, according to embodiments.

As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

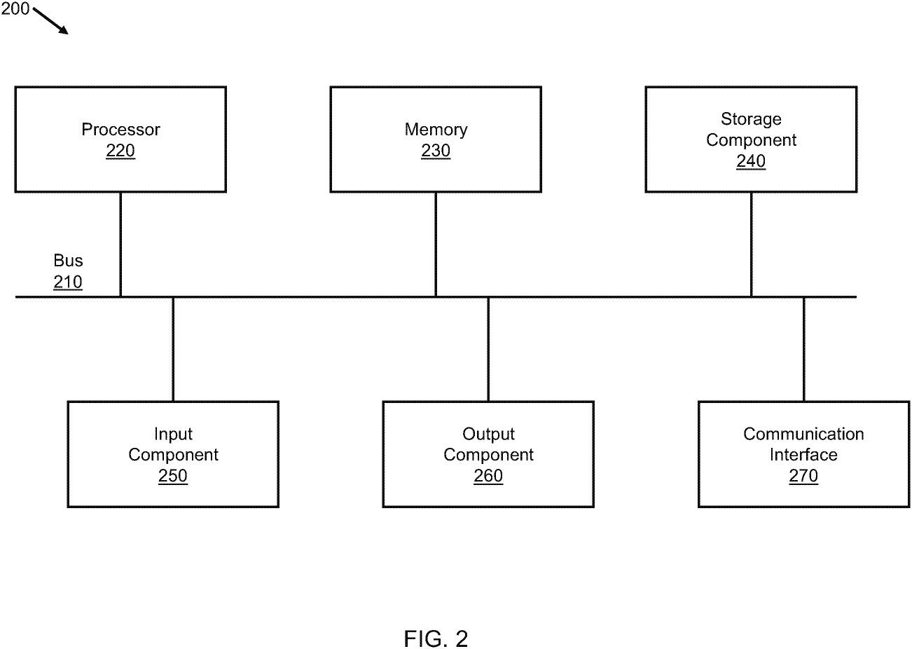

FIG. 2 is a block diagram of example components of one or more devices of FIG. 1.

A device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). Additionally, or alternatively, the input component 250 may include a sensor for sensing information (e.g., a global positioning system (GPS) component, an accelerometer, a gyroscope, and/or an actuator). The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

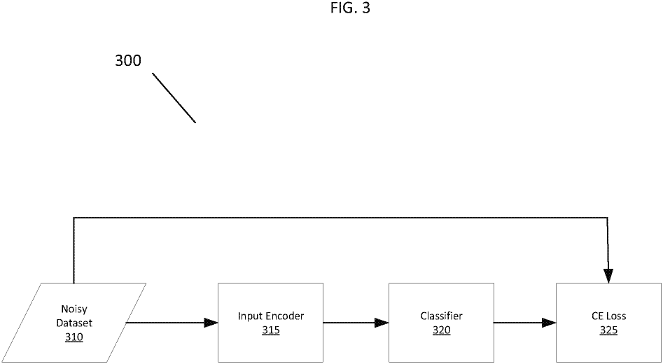

FIG. 3 illustrates an example block diagram of training framework 300 for training a classification model, according to embodiments.

As shown in FIG. 3, the training framework 300 includes a noisy dataset 310, an input encoder 315, a classifier 320, and a loss function 325.

The noisy dataset 310 is a collection of data and/or information that may be used by a computer for analytics an prediction purposes. The noisy dataset 310 may include data and annotated labels that may be generated using machine learning algorithms and not by human annotators. The machine learned annotations or labels may be quite noisy when compared to expert annotation.

The input encoder 315 may be an input encoder trainable and configured to encode input tokens from the noisy dataset 310 into input vectors. The classifier 320 may predict a label for the input token based on the input vectors using a classifier model. Based on the prediction made by the classifier 320, and the labels in the noisy dataset 310, a loss function 325 may calculate the loss and update the input encoder and classifier model.

The classifier 320 and the input encoder 315 may be implemented using any suitable machine learning model. As an example, the classifier 320 and the input encoder 315 may be implemented using like regression models, neural networks, etc.

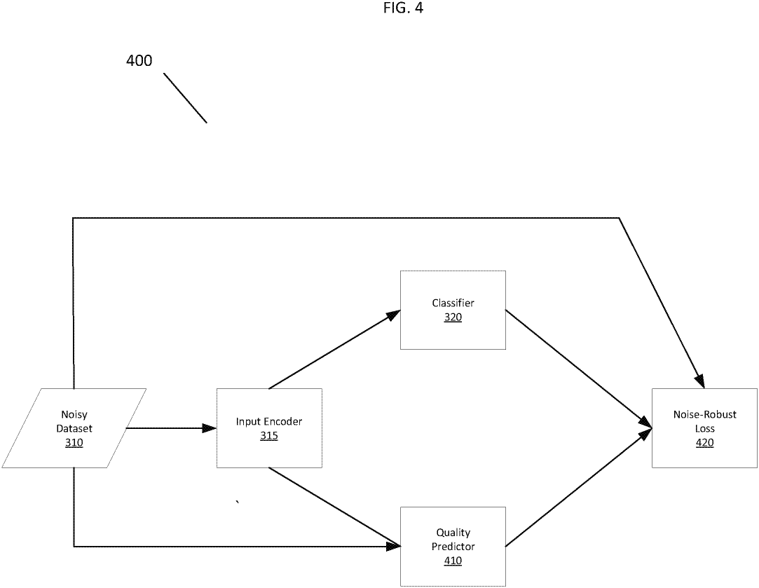

FIG. 4 illustrates an example block diagram of training framework 400 for jointly training more than one classification model, according to embodiments.

As shown in FIG. 4, the training framework 400 includes the noisy dataset 310, the input encoder 315, the classifier 320, a quality predictor or label quality predictor 410 and a noise-robust loss function 420.

The noisy dataset 310 may include data and/or information and labels associated with said data or information. In some embodiments, the labels may be generated using an automated pipeline via machine learning. The input encoder 315 may be configured encode input tokens from the noisy dataset 310 into input vectors. The classifier 320 may predict a label for the input token based on the input vectors using a classifier model.

The label quality predictor 410 may be a machine learned model configured to analyze the encoded input and the labels from the noisy dataset 310 to predict an instance-specific β value that captures the relationship the encoded input and the label. The label quality predictor 410 may be implemented using any suitable machine learning model and may take complex forms depending on prior knowledge about the relationship between the inputs and the labels in the noisy dataset. As an example, the classifier label quality predictor 410 may be implemented using like regression models, neural networks, etc.

The noise-robust loss function 420 may jointly update the input encoder 315, the classifier 320, and the label quality predictor 410 based on the classifier 320 predicted label, the label in the noisy dataset 310, and the instance-specific β value predicted by the label quality predictor 410. By jointly updating all the models using an instance-specific β value that indicates the noisiness of the label in the noisy dataset 310, the noise-robust loss function accounts for the noisy labels generated by the machine learned models. In some embodiments, the noise-robust loss function may jointly update only the input encoder 315 and the label quality predictor 410. As an example, the joint training of the label quality predictor 410, the input encoder 315, and the classifier 320 using the noise-robust loss function 420 may include updating the models within the label quality predictor 410, the input encoder 315, and the classifier 320. In some embodiments, the noise-robust loss function may jointly update only the input encoder 315 and the classifier 320.

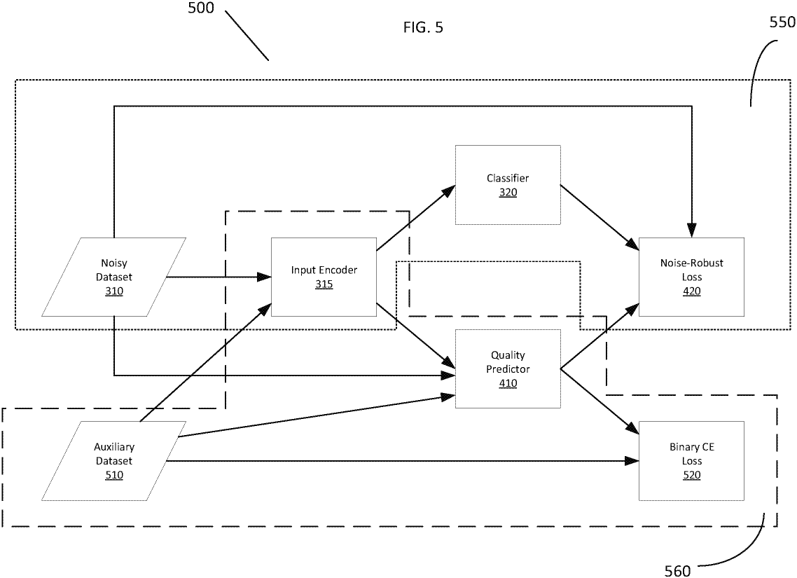

FIG. 5 illustrates an example block diagram of training framework 500 for jointly training more than one classification model, according to embodiments.

As shown in FIG. 5, the training framework 500 includes the noisy dataset 310, the input encoder 315, the classifier 320, a quality predictor or label quality predictor 410, the noise-robust loss function 420, an auxiliary dataset 510, and a binary CE loss function 520.

The noisy dataset 310 may include data and/or information and labels associated with said data or information. In some embodiments, the labels may be generated using an automated pipeline via machine learning. The input encoder 315 may be configured encode input tokens from the noisy dataset 310 into input vectors. The classifier 320 may predict a label for the input token based on the input vectors using a classifier model.

Correcting the noisy dataset 310 may be very expensive, however, since additional supervision of the label quality predictor 410 is needed, an auxiliary dataset 510 may be utilized wherein the auxiliary dataset 510 may include manual annotation of the correctness of a label in the noisy dataset 310. As an example, the auxiliary dataset 510 may include the data and label from the noisy dataset 310 and an additional manual correctness label which indicates a manual correctness of the corresponding label in the noisy dataset 310. In some embodiments, if the label from the noisy dataset 310 is incorrect, then the manual correctness label for this training instance in the auxiliary dataset may be 0, otherwise it may be 1. In some embodiments, if the label from the noisy dataset 310 is correct, then the manual correctness label for this training instance in the auxiliary dataset may be 1, otherwise it may be 0. Using the manual correctness label in the auxiliary dataset 510 for additional training of the label quality predictor 410 enables effectively correcting the labels in the noisy dataset 310 without actually correcting or modifying the noisy dataset 310. The additional supervision and training of the label quality predictor 410 may help the label quality predictor 410 better understand the relationship between the input, the label in the noisy dataset 310, and the noise level of the instance.

The label quality predictor 410 may be a machine learned model configured to analyze the encoded input and the labels from the noisy dataset 310 to predict an instance-specific β value that captures the relationship the encoded input and the label. The label quality predictor 410 may be additionally trained, jointly with the input encoder 315, using sampled data from the auxiliary dataset 510. During the additional joint training the label quality predictor 410 may predict an instance-specific β value based on the encoded input, the label in the noisy dataset 310, and the manual correctness label from the auxiliary dataset 510. The binary CE loss function 520 may jointly update the label quality predictor 410 and the input encoder 315. As an example, the joint training of the label quality predictor 410 and the input encoder 315 using the binary CE loss function 520 may include updating the models within the label quality predictor 410 and the input encoder 315.

The noise-robust loss function 420 may jointly train the input encoder 315 and the classifier 320 based on the classifier 320 predicted label, the label in the noisy dataset 310, and the instance-specific β value predicted by the label quality predictor 410 wherein the label quality predictor 410 may have been additionally trained using training data sampled from the auxiliary dataset 510. By jointly updating the input encoder 315 and the classifier 320 using an instance-specific β value that indicates the noisiness of the label in the noisy dataset 310, the noise-robust loss function accounts for the noisy labels generated by the machine learned models. As an example, the joint training of the input encoder 315 and the classifier 320 using the noise-robust loss function 420 may include updating the models within the input encoder 315 and the classifier 320 based on the noise-robust loss function 420. In some embodiments, as the noise-robust loss function 420 jointly updates the input encoder 315 and the classifier 320, the label quality predictor may not be updated.

The label quality predictor 410, the classifier 320, and the input encoder 315 may be implemented using any suitable machine learning model and may take complex forms depending on prior knowledge about the relationship between the inputs and the labels in the noisy dataset. As an example, the classifier label quality predictor 410 may be implemented using like regression models, neural networks, etc.

Section 550 in FIG. 5 includes to the components in the training framework 500 involved in jointly training the input encoder 315 and the classifier 320 using the noise-robust loss function 420. Section 560 in FIG. 5 includes to the components in the training framework 500 involved in jointly training the input encoder 315 and the label quality predictor 410 using the binary CE loss function 520.

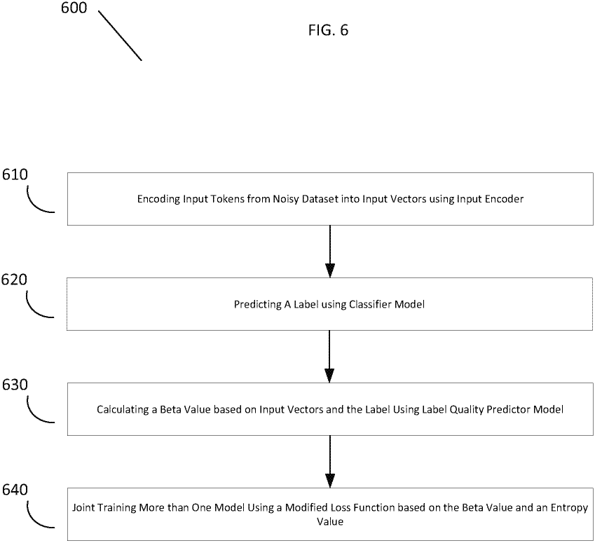

FIG. 6 illustrates and example process 600 for a joint training method with noise-robust losses.

At operation 610, the input encoder may encode input tokens from a noisy dataset into input vectors. At operation 620, a classifier may predict a label based on the input vectors. At operation 630, the label quality predictor may calculate an instance-specific β (beta) value based on the input vectors and the predicted label. At operation 640, jointly training more than one model using a first modified loss function based on the β value and an entropy value. In some embodiments, the entropy value may be an entropy function configured to measure and/or create randomness in the information being processed.

As an example, the input encoder 315 may be used to encode input tokens from the noisy dataset 310 into input tokens. The classifier 320 may predict a label based on the input vectors using a classification and/or classifier model. The label quality predictor 410 may calculate an instance-specific β value based on the input vectors and the label. Then, the noise-robust loss function 420 may be used to jointly train more than one models based on the instance-specific β value and the entropy value. As an example, the joint training of the more than one models may include updating the models within the input encoder 315, the label quality predictor 410, and the classifier 320 based on the noise-robust loss function 420.

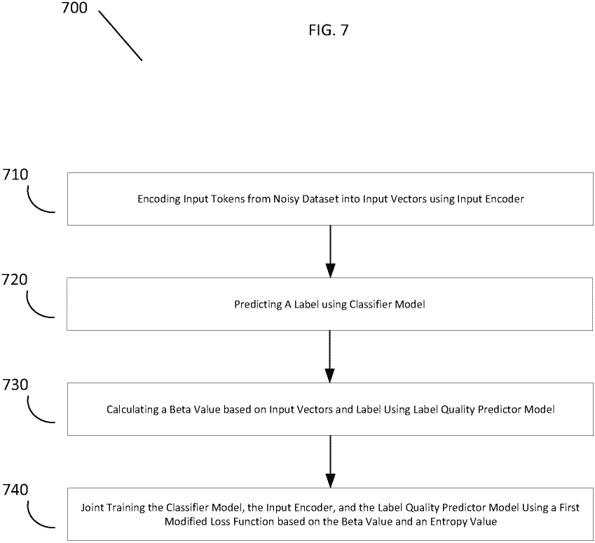

FIG. 7 illustrates and example process 700 for a joint training method with noise-robust losses.

At operation 710, the input encoder may encode input tokens from a noisy dataset into input vectors. At operation 720, a classifier may predict a label based on the input vectors. At operation 730, the label quality predictor may calculate an instance-specific β (beta) value based on the input vectors and the predicted label. At operation 740, the input encoder, the classifier model, and the label quality predictor model may be jointly trained using a first modified loss function based on the β value and an entropy value. In some embodiments, the entropy value may be an entropy function configured to measure and/or create randomness in the information being processed.

As an example, the input encoder 315 may be used to encode input tokens from the noisy dataset 310 into input tokens. The classifier 320 may predict a label based on the input vectors using a classification and/or classifier model. The label quality predictor 410 may calculate an instance-specific β value based on the input vectors and the label. Then, the noise-robust loss function 420 may be used to jointly train the input encoder, the classifier, and the label quality predictor based on the instance-specific β value and the entropy value. As an example, the joint training of the input encoder, the classifier, and the label quality predictor may include updating the models within the input encoder 315, the label quality predictor 410, and the classifier 320 based on the noise-robust loss function 420.

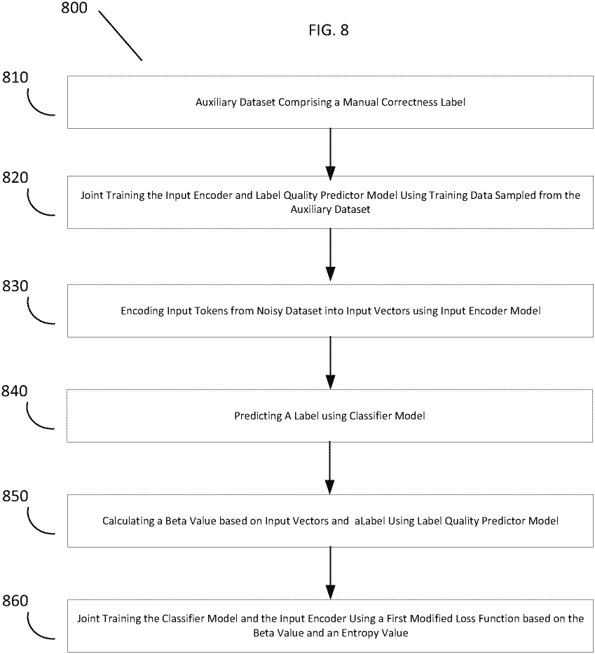

FIG. 8 illustrates and example process 800 for a joint training method with noise-robust losses.

At operation 810, an auxiliary dataset may be generated. The auxiliary dataset may include data and/or information from the noisy dataset and may also include a manual correctness label which indicates a manual correctness of a corresponding label in the noisy dataset. The auxiliary dataset may also include an annotated label which may be the same as the machine generated label in the noisy dataset.

At operation 820, the input encoder and the label quality predictor model may be jointly trained using training data sampled from an auxiliary dataset. The training data sampled from the auxiliary dataset may include the manual correctness label and the data and/or information. Jointly training the input encoder and the label quality predictor model may include encoding input tokens from the auxiliary dataset into auxiliary input vectors using the input encoder. Further, jointly training the input encoder and the label quality predictor model may include calculating an auxiliary β value based on the auxiliary input vectors and an annotated label in the auxiliary dataset, wherein the auxiliary β value is instance-specific for the each training instance. Additionally, jointly training the input encoder and the label quality predictor model may include joint training of the input encoder and the label quality predictor model using a second modified loss function based on the auxiliary β value and the manual correctness label. In some embodiments, joint training of the input encoder and the label quality predictor model using a second modified loss function based on the auxiliary β value and the manual correctness label may include updating the models in the input encoder and the label quality predictor based on the second modified loss function.

At operation 830, the input encoder may encode input tokens from a noisy dataset into input vectors. At operation 840, a classifier may predict a label based on the input vectors. At operation 850, the label quality predictor may calculate an instance-specific β (beta) value based on the input vectors and the predicted label. In some embodiments, the instance-specific β value calculated at operation 850 may be equivalent to the auxiliary beta value calculated at operation 820.

At operation 860, the input encoder and the classifier model may be jointly trained using a first modified loss function based on the β value and an entropy value. In some embodiments, the entropy value may be an entropy function configured to measure and/or create randomness in the information being processed.

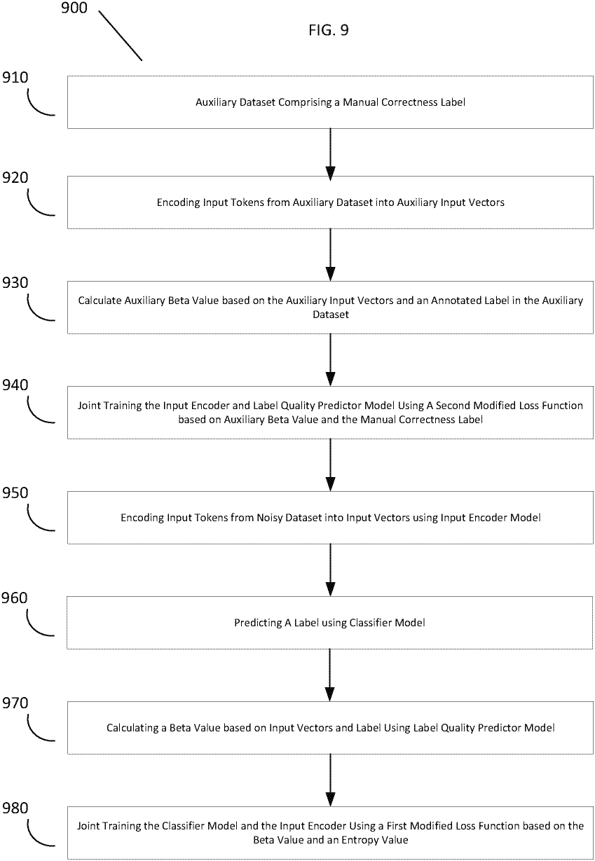

FIG. 9 illustrates and example process 900 for a joint training method with noise-robust losses.

At operation 910, an auxiliary dataset may be generated. The auxiliary dataset may include data and/or information from the noisy dataset and may also include a manual correctness label which indicates a manual correctness of a corresponding label in the noisy dataset. The auxiliary dataset may also include an annotated label which may be the same as the machine generated label in the noisy dataset.

At operations 920 - 940, the input encoder and the label quality predictor model may be jointly trained using training data sampled from the auxiliary dataset. Jointly training the input encoder and the label quality predictor model may include, at operation 920, encoding input tokens from the auxiliary dataset into auxiliary input vectors using the input encoder. Further, jointly training the input encoder and the label quality predictor model may include, at operation 930, calculating an auxiliary β value based on the auxiliary input vectors and an annotated label in the auxiliary dataset, wherein the auxiliary β value is instance-specific for the each training instance. At 940, jointly training the input encoder and the label quality predictor model may include joint training of the input encoder and the label quality predictor model using a second modified loss function based on the auxiliary β value and the manual correctness label. In some embodiments, joint training of the input encoder and the label quality predictor model using a second modified loss function based on the auxiliary β value and the manual correctness label may include updating the models in the input encoder and the label quality predictor based on the second modified loss function.

At operation 950, the input encoder may encode input tokens from a noisy dataset into input vectors. At operation 960, a classifier may predict a label based on the input vectors. At operation 970, the label quality predictor may calculate an instance-specific β (beta) value based on the input vectors and the predicted label. In some embodiments, the instance-specific β value calculated at operation 970 may be equivalent to the auxiliary beta value calculated at operation 930.

At operation 980, the input encoder and the classifier model may be jointly trained using a first modified loss function based on the β value and an entropy value. In some embodiments, the entropy value may be an entropy function configured to measure and/or create randomness in the information being processed.

As an example, an auxiliary dataset 510 may be utilized wherein the auxiliary dataset 510 may include manual annotation of the correctness of a label in the noisy dataset 310. In some embodiments, the auxiliary dataset 510 may include the data and label from the noisy dataset 310 and an additional manual correctness label which indicates a manual correctness of the corresponding label in the noisy dataset 310. The label quality predictor 410 may be additionally trained, jointly with the input encoder 315, using sampled data from the auxiliary dataset 510. During the additional joint training the label quality predictor 410 may predict an instance-specific β value based on the encoded input, the label in the noisy dataset 310, and the manual correctness label from the auxiliary dataset 510. A second loss function, e.g., a binary CE loss function 520 may jointly update the label quality predictor 410 and the input encoder 315.

The noise-robust loss function 420 may jointly train the input encoder 315 and the classifier 320 based on the classifier 320 predicted label, the label in the noisy dataset 310, and the instance-specific β value predicted by the label quality predictor 410. As an example, the joint training of the input encoder 315 and the classifier 320 using the noise-robust loss function 420 may include updating the models within the input encoder 315 and the classifier 320 based on the noise-robust loss function 420. In some embodiments, as the noise-robust loss function 420 jointly updates the input encoder 315 and the classifier 320, the label quality predictor may not be updated.

Although FIGS. 6-9 show example blocks of the processes 600, 700, 800, and 900, in embodiments, the processes 600, 700, 800, and 900 may include additional blocks, fewer blocks, different blocks, or differently arranged blocks than those depicted in FIGS. 6-9. In embodiments, any blocks of processes 600, 700, 800, and 900 may be combined or arranged in any amount or order, as desired. In embodiments, two or more of the blocks of the processes 600, 700, 800, and 900 may be performed in parallel.

The techniques described above, can be implemented as computer software using computer-readable instructions and physically stored in one or more computer-readable media or by a specifically configured one or more hardware processors. For example, FIG. 1 shows an environment 100 suitable for implementing various embodiments.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A joint training method using neural networks with noise-robust losses comprising:
encoding input tokens from a noisy dataset into input vectors using an input encoder;
predicting a label based on the input vectors using a classifier model;
calculating a beta value based on the input vectors and the label using a label quality predictor model, wherein the beta value is instance-specific for each training instance; and
joint training more than one model using a first modified loss function based on the beta value and an entropy value.

2. The joint training method of claim 1, wherein the joint training of the more than one model comprises jointly training the classifier model, the input encoder, and the label quality predictor model using the first modified loss function.

3. The joint training method of claim 1,
wherein the input encoder and the label quality predictor model are jointly trained using training data sampled from an auxiliary dataset, and
wherein the auxiliary dataset comprises a manual correctness label which indicates a manual correctness of a corresponding label in the noisy dataset.

4. The joint training method of claim 3, wherein the joint training of the input encoder and the label quality predictor model comprises:
encoding input tokens from the auxiliary dataset into auxiliary input vectors using the input encoder;
calculating an auxiliary beta value based on the auxiliary input vectors and an annotated label in the auxiliary dataset, wherein the auxiliary beta value is instance-specific for the each training instance; and
joint training of the input encoder and the label quality predictor model using a second modified loss function based on the auxiliary beta value and the manual correctness label.

5. The joint training method of claim 1, wherein the joint training of the more than one model comprises jointly training the classifier model and the input encoder using the first modified loss function.

6. The joint training method of claim 1, wherein the beta value is higher than a threshold.

7. The joint training method of claim 1, wherein prior to calculating the beta value based on the input vectors and the label, the beta value is set to one for a limited number of epochs.

8. The joint training method of claim 3, wherein the manual correctness label is set to 1 if the corresponding label in the noisy dataset is accurate.

9. The joint training method of claim 1, wherein the beta value is lower bounded by a function of beta mu.

10. An apparatus for joint training using neural networks with noise-robust losses, the apparatus comprising:
at least one memory configured to store computer program code;
at least one processor configured to access the computer program code and operate as instructed by the computer program code, the computer program code including:
first encoding code configured to cause the at least one processor to encode input tokens from a noisy dataset into input vectors using an input encoder;
first predicting code configured to cause the at least one processor to predict a label based on the input vectors using a classifier model;
first calculating code configured to cause the at least one processor to calculate a beta value based on the input vectors and the label using a label quality predictor model, wherein the beta value is instance-specific for each training instance; and
first joint training code configured to cause the at least one processor to jointly train more than one model using a first modified loss function based on the beta value and an entropy value.

11. The apparatus of claim 10, wherein the first joint training code further comprises:
second joint training code configured to cause the at least one processor to jointly train the classifier model, the input encoder, and the label quality predictor model using the first modified loss function.

12. The apparatus of claim 10,
wherein the input encoder and the label quality predictor model are jointly trained using training data sampled from an auxiliary dataset, and
wherein the auxiliary dataset comprising a manual correctness label which indicates a manual correctness of a corresponding label in the noisy dataset.

13. The apparatus of claim 12, wherein the joint training of the input encoder and the label quality predictor model comprises:
second encoding code configured to cause the at least one processor to encode input tokens from the auxiliary dataset into auxiliary input vectors using the input encoder;
second calculating code configured to cause the at least one processor to calculate an auxiliary beta value based on the auxiliary input vectors and an annotated label in the auxiliary dataset, wherein the auxiliary beta value is instance-specific for the each training instance; and
third joint training code configured to cause the at least one processor to jointly train the input encoder and the label quality predictor model using a second modified loss function based on the auxiliary beta value and the manual correctness label.

14. The apparatus of claim 10, wherein the first joint training code further comprises:
second joint training code configured to cause the at least one processor to jointly train the classifier model and the input encoder using the first modified loss function.

15. The apparatus of claim 10, wherein prior to the first calculating code, the beta value is set to one for a limited number of epochs.

16. The apparatus of claim 10, wherein the beta value is higher than a threshold.

17. A non-transitory computer readable medium storing a program to execute a process, the process comprising:
encoding input tokens from a noisy dataset into input vectors using an input encoder;
predicting a label based on the input vectors using a classifier model;
calculating a beta value based on the input vectors and the label using a label quality predictor model, wherein the beta value is instance-specific for each training instance; and
joint training more than one model using a first modified loss function based on the beta value and an entropy value.

18. A non-transitory computer readable medium of claim 17, wherein the joint training of the more than one model comprises jointly training the classifier model, the input encoder, and the label quality predictor model using the first modified loss function.

19. A non-transitory computer readable medium of claim 17,
wherein the input encoder and the label quality predictor model are jointly trained using training data sampled from an auxiliary dataset, and
wherein the auxiliary dataset comprising a manual correctness label which indicates a manual correctness of a corresponding label in the noisy dataset.

20. A non-transitory computer readable medium of claim 17, wherein the joint training of the more than one model comprises jointly training the classifier model and the input encoder using the first modified loss function based on the beta value and the entropy value.
